(19) United States
(12) Patent Application Publication
(10) Pub. No.: US 2025/0162526 A1
(43) Pub. Date: May 22, 2025

(54) CHARGING SYSTEM AND VEHICLE

(71) Applicant: TOYOTA JIDOSHA KABUSHIKI KAISHA, Toyota-shi (JP)

(72) Inventor: Tetsuaki OKADA, Toyota-shi (JP)

(73) Assignee: TOYOTA JIDOSHA KABUSHIKI KAISHA, Toyota-shi (JP)

(21) Appl. No.: 18/936,222

(22) Filed: Nov. 4, 2024

(30) Foreign Application Priority Data
Nov. 21, 2023 (JP) 2023-197297

(51) Int. Cl. B60R 16/033; H01M 10/0525; H01M 10/42; H01M 10/48; H01M 50/581; H02J 7/00

(52) U.S. Cl. CPC B60R 16/033; H01M 10/0525; H01M 10/425; H01M 10/486; H01M 50/581; H01M 2200/10; H01M 2220/20; H02J 7/0047

(57) ABSTRACT

A charging system includes: a motor generator; a lithium-ion battery accumulating an electric power generated by the motor generator; a relay electrically connecting the motor generator and the lithium-ion battery; a first processor acquiring battery information and giving an instruction on an electric power generation amount of the motor generator; and a second processor controlling an operation of the motor generator in accordance with the instruction. The first processor, in a case where an interruption of the instruction to the second processor is detected, calculates a charging allowable electric power that is an upper limit value of a charging electric power into the lithium-ion battery in which lithium precipitation does not occur, based on the battery information, and cuts off the relay when a state where the charging allowable electric power is lower than a predetermined electric power continues for a predetermined time or longer.

### CROSS-REFERENCE TO RELATED APPLICATION

This application claims priority to Japanese Patent Application No. 2023-197297 filed on Nov. 21, 2023, incorporated herein by reference in its entirety.

### BACKGROUND

### 1. Technical Field

The present disclosure relates to a charging system and a vehicle.

### 2. Description of Related Art

In a case where a lithium-ion battery is further charged in a state where a state of charge (SOC) is high or is charged in an extremely low temperature state, a phenomenon in which lithium metal leading to battery deterioration is precipitated (lithium precipitation) occurs. Therefore, various techniques for suppressing occurrence of the lithium precipitation have been proposed for the lithium-ion battery.

WO 2010/005079 discloses a system that charges a lithium-ion battery with an electric power generated by a motor generator in a hybrid vehicle. In the system disclosed in WO 2010/005079, an operation command is given from an electronic control unit that monitors a state of the lithium-ion battery to an electronic control unit that controls the motor generator such that the electric power (charging electric power) input to the lithium-ion battery from the motor generator is equal to or lower than an input limit electric power value at which the occurrence of the lithium precipitation can be suppressed.

### SUMMARY

In the system disclosed in WO 2010/005079, for example, in a case where the electronic control unit that monitors the state of the lithium-ion battery cannot receive the operation command transmitted from the electronic control unit that controls the motor generator due to a cause, such as interruption of communication, the electric power generation of the motor generator based on the input limit electric power value cannot be appropriately controlled. Therefore, there is a concern that the motor generator generates an excessive amount of the electric power and the lithium precipitation occurs in the lithium-ion battery.

The present disclosure provides a charging system and the like that can suppress occurrence of lithium precipitation in a lithium-ion battery in a case where electric power generation of a motor generator cannot be appropriately controlled.

An aspect of the technique of the present disclosure relates to a charging system mounted in a vehicle. The charging system includes a motor generator, a lithium-ion battery, a relay, a first processor, and a second processor. The lithium-ion battery is configured to accumulate an electric power generated by the motor generator. The relay is configured to electrically connect the motor generator and the lithium-ion battery to each other. The first processor is configured to acquire battery information including a temperature, a current, and a usage period of the lithium-ion battery and give an instruction on an electric power generation amount of the motor generator based on the battery information. The second processor is configured to control an operation of the motor generator in accordance with the instruction from the first processor. The first processor is configured to, in a case where an interruption of the instruction to the second processor is detected, calculate a charging allowable electric power that is an upper limit value of a charging electric power into the lithium-ion battery in which lithium precipitation does not occur, based on the battery information, and cut off the relay when a state where the charging allowable electric power is lower than a predetermined electric power continues for a predetermined time or longer.

With the charging system according to the present disclosure, in a case where the instruction to the motor generator is interrupted and the electric power generation cannot be appropriately controlled, a state where the lithium precipitation is likely to occur in the lithium-ion battery is predicted and the relay is cut off. As a result, the occurrence of the lithium precipitation in the lithium-ion battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a charging system according to an embodiment of the present disclosure;

FIG. 2 is a process flowchart of a first example of a battery charging control that is executed by the charging system; and

FIG. 3 is a process flowchart of a second example of the battery charging control that is executed by the charging system.

### DETAILED DESCRIPTION OF EMBODIMENTS

In a charging system according to the present disclosure, in a case where electric power generation of a motor generator that charges a lithium-ion battery cannot be controlled, a charging path from the motor generator to the lithium-ion battery is electrically disconnected when there is a possibility of lithium precipitation in the lithium-ion battery. As a result, the electric power generated by the motor generator is not supplied to a lithium-ion battery 111, and occurrence of a phenomenon in which lithium metal is precipitated beyond a limit in the lithium-ion battery 111 can be avoided.

Hereinafter, an embodiment of the present disclosure will be described in detail with reference to the drawings.

### Embodiment

### Configuration

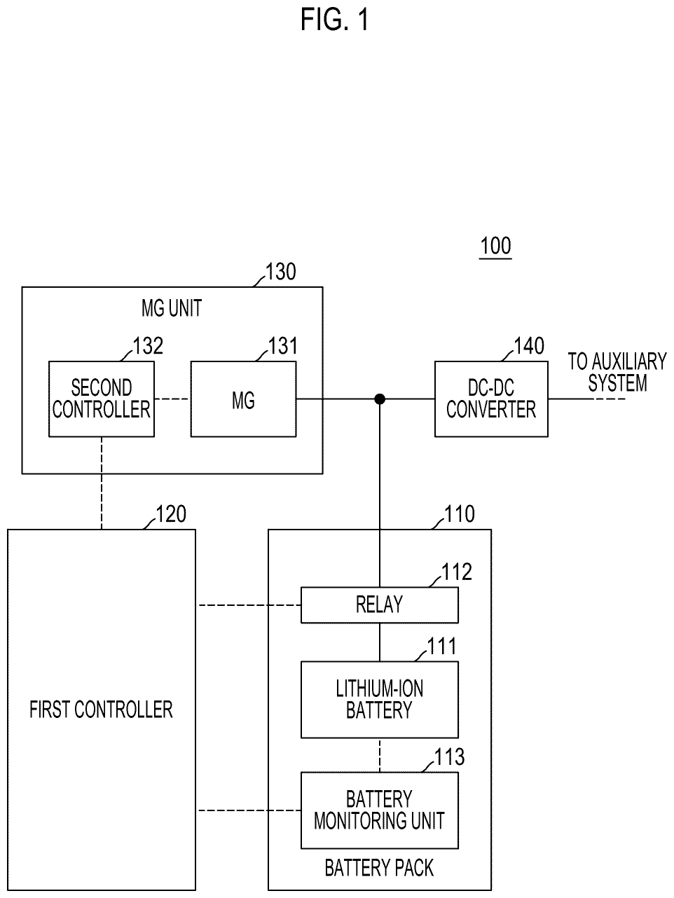

FIG. 1 is a block diagram showing a schematic configuration example of a charging system 100 according to the embodiment of the present disclosure. In FIG. 1, the charging system 100 includes a battery pack 110, a first controller 120, an MG unit 130, and a DC-DC converter 140. In FIG. 1, an electric power line through which an electric power is transmitted and received is shown by a solid line, and a signal line that carries a detection value, an instruction, or the like is shown by a broken line. The charging system 100 is mounted in a vehicle, such as a hybrid electric vehicle (HEV) including an internal combustion engine as a power source.

The battery pack 110 is an electric power source that can supply the electric power to the MG unit 130 or an auxiliary system (not shown) of the vehicle, or accumulate the electric power generated by the MG unit 130. The battery pack 110 includes a lithium-ion battery 111, a relay 112, and a battery monitoring unit 113.

The lithium-ion battery 111 is a chargeable-dischargeable secondary battery using lithium ions for movement between electrodes. The lithium-ion battery 111 is connected to the MG unit 130 and the DC-DC converter 140 via the relay 112. The lithium-ion battery 111 is rated at a voltage (for example, 48 V) needed to drive the MG unit 130 that assists an operation of the vehicle.

The relay 112 is provided between the MG unit 130 and the lithium-ion battery 111, and has a configuration for controlling an electrical connection state (conduction/cutoff) between the MG unit 130 and the lithium-ion battery 111. The relay 112 switches between a conduction state and a cutoff state in accordance with the control of the first controller 120.

The battery monitoring unit 113 has a configuration for monitoring the state of the lithium-ion battery 111. The battery monitoring unit 113 monitors information, such as a voltage, a current, and a temperature of the lithium-ion battery 111. The monitoring of these types of information can be performed using a detection device, such as a sensor (not shown). The information monitored by the battery monitoring unit 113 is acquired by the first controller 120.

The first controller 120 has a configuration for controlling an operation of the MG unit 130 based on the state of the lithium-ion battery 111, the electric power consumption of the auxiliary system (not shown), and the like. The first controller 120 controls the operation of the MG unit 130, for example, by the first controller 120 notifying the MG unit 130 of a predetermined instruction (on a torque, an electric power generation amount, or the like) via an in-vehicle network, such as a controller area network (CAN). As one of the controls, the first controller 120 according to the present embodiment calculates a charging allowable electric power that is an upper limit value of a charging electric power into the lithium-ion battery 111 in which lithium precipitation does not occur, based on the state of the lithium-ion battery 111 acquired from the battery monitoring unit 113 and information about the battery, such as an usage period (elapsed time) of the lithium-ion battery 111 in the vehicle derived from the state, a history of charging and discharging performed in the usage period, and a degree of aging deterioration (estimated capacity decrease amount), and performs the control of the state of the relay 112 based on the charging allowable electric power. In addition, the first controller 120 can detect the interruption of the CAN communication to grasp that the instruction to the MG unit 130 is not given.

The first controller 120 is typically configured as an electronic control unit (ECU), such as a microcomputer, including a processor, a memory, and an input/output interface. The electronic control unit realizes the above-described functions by the processor reading a program stored in the memory to execute the program.

The MG unit 130 has a configuration for assisting a specific operation (driving force, engine start, or the like) in the vehicle or recovering a regenerative electric power generated during traveling of the vehicle. The MG unit 130 includes a motor generator (MG) 131 and a second controller 132.

The motor generator (MG) 131 is a device that has a function of an electric motor and a function of a generator. The motor generator 131 is connected to the lithium-ion battery 111 of the battery pack 110, is driven by receiving the electric power supplied from the lithium-ion battery 111 when the motor generator 131 functions as the electric motor, and supplies (charges) the generated electric power into the lithium-ion battery 111 or the auxiliary system (not shown) when the motor generator 131 functions as the generator.

The second controller 132 has a configuration (for example, a microcomputer) that controls an operation of the motor generator 131. The second controller 132 can control the torque or the electric power generation amount of the motor generator 131 in accordance with an operation instruction for which the notification is given from the first controller 120 via the CAN or the like.

The DC-DC converter 140 is provided between the battery pack 110 and the MG unit 130, and the auxiliary system (not shown), and is an electric power converter that converts the input electric power generated by the MG unit 130 or the input electric power accumulated in the battery pack 110 into a needed voltage, and outputs the converted electric power to the auxiliary system. The auxiliary system (not shown) includes, for example, a lead storage battery having 12 V as a rated voltage, and an in-vehicle load driven by a voltage of 12 V.

### Control

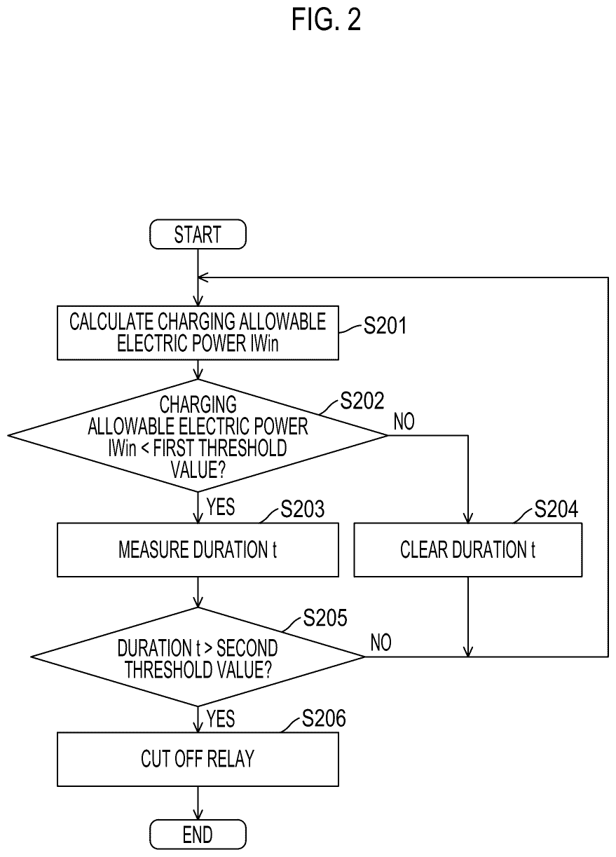

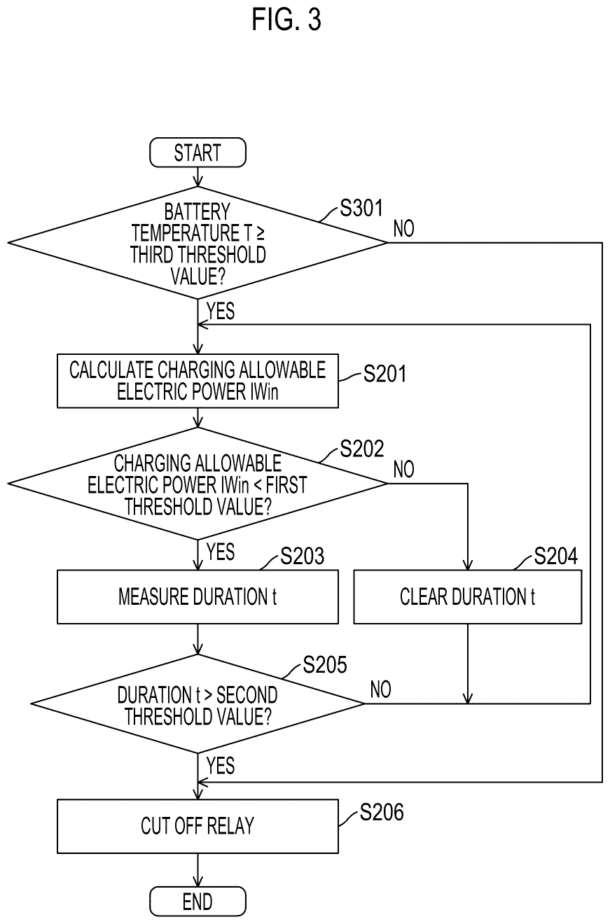

Next, the control performed by the charging system 100 according to the embodiment of the present disclosure will be described with further reference to FIGS. 2 and 3. FIG. 2 is a flowchart showing a process procedure of a first example of a lithium-ion battery charging control that is executed by the first controller 120 of the charging system 100. FIG. 3 is a flowchart showing a process procedure of a second example of the lithium-ion battery charging control that is executed by the first controller 120 of the charging system 100.

### (1) First Example

The lithium-ion battery charging control of the first example shown in FIG. 2 is started, for example, in a case where the CAN communication between the first controller 120 and the second controller 132 is interrupted, and the notification for the operation instruction (on the electric power generation amount) of the motor generator 131 from the first controller 120 to the second controller 132 is not given. The MG unit 130 that is not notified of the operation instruction proceeds to a fail-safe mode for driving the motor generator 131 via autonomous electric power generation.

### Step S201

The first controller 120 calculates a charging allowable electric power IWin that is the upper limit value of the charging electric power into the lithium-ion battery 111 in which the lithium precipitation does not occur. The charging allowable electric power IWin can be obtained, for example, by the following calculation.

First, based on the history of charging and discharging of the lithium-ion battery 111, a current value Ilim at which the lithium metal is precipitated by a negative electrode potential being decreased to a lithium reference potential when the charging continues is calculated. Next, a target current value Itag (=Ilim+ΔI) in which a margin ΔI is added to the current value Ilim is calculated. Then, the charging allowable electric power IWin (=Itag×Vbad) is obtained by multiplying the target current value Itag by an assumed worst value Vbad of the voltage.

In a case where the charging allowable electric power IWin is calculated by the first controller 120, the process proceeds to step S202.

### Step S202

The first controller 120 determines whether or not the charging allowable electric power IWin is lower than a first threshold value. The determination is made to determine whether or not the charging allowable electric power IWin reaches a danger zone having a possibility of the lithium precipitation occurring in the lithium-ion battery 111. The first threshold value is set to a predetermined electric power in which the charging allowable electric power IWin falls below the maximum electric power with which the lithium-ion battery 111 can be charged during the autonomous electric power generation. Since the first threshold value brings a trade-off relationship between the safety of the lithium-ion battery 111 in which the lithium precipitation does not occur and the recovery efficiency of the electric power generated by the motor generator 131, the first threshold value needs to be appropriately set. As an example, the total of the electric power consumption of the auxiliary system (not shown) of the vehicle that operates during the autonomous electric power generation (during the fail-safe) can be set as the first threshold value.

In a case where the first controller 120 determines that the charging allowable electric power IWin is lower than the first threshold value (step S202, YES), the process proceeds to step S203. On the other hand, in a case where the first controller 120 determines that the charging allowable electric power IWin is equal to or higher than the first threshold value (step S202, NO), the process proceeds to step S204.

### Step S203

The first controller 120 measures a time (duration t) during which a state where the charging allowable electric power IWin is lower than the first threshold value continues. Here, the first controller 120 starts a new time measurement in a case where the time measurement of the duration t is not performed, and continues the time measurement in a case where the time measurement of the duration t is already performed.

In a case where the first controller 120 measures the duration t of the state where the charging allowable electric power IWin is lower than the first threshold value, the process proceeds to step S205.

### Step S204

The first controller 120 clears the measured duration t. This process is based on a determination that the state where the charging allowable electric power IWin is lower than the first threshold value is interrupted and the charging allowable electric power IWin has exited the danger zone of the lithium precipitation.

In a case where the first controller 120 clears the duration t, the process proceeds to step S201.

### Step S205

The first controller 120 determines whether or not the duration t is longer than a second threshold value. The determination is made to avoid the occurrence of the lithium precipitation in the lithium-ion battery 111 caused by the charging allowable electric power IWin. The second threshold value is a predetermined time determined based on a relationship between a change tendency of the charging allowable electric power IWin after the charging allowable electric power IWin is lower than the first threshold value and an electric power (lithium precipitation line) estimated to cause the lithium metal to be precipitated. For example, the second threshold value can be determined by considering a control time (response time) needed from a time of the instruction to a time when the relay 112 actually performs a cutoff operation.

In a case where the first controller 120 determines that the duration t is longer than the second threshold value (step S205, YES), the process proceeds to step S206. On the other hand, in a case where the first controller 120 determines that the duration t is equal to or lower than the second threshold value (step S205, NO), the process proceeds to step S201.

### Step S206

The first controller 120 controls the relay 112 to be in the cutoff state. With this control, the electric power generated by the motor generator 131 is not supplied to the lithium-ion battery 111, and thus the occurrence of the lithium precipitation in the lithium-ion battery 111 can be avoided.

In a case where the relay 112 is controlled to be in the cutoff state by the first controller 120, the lithium-ion battery charging control ends.

In the lithium-ion battery charging control of the first example, in a case where the lithium-ion battery 111 is in a state where the occurrence of the lithium precipitation is concerned, the relay 112 is not cut off immediately when the charging allowable electric power IWin falls below the first threshold value, but the relay 112 is cut off after waiting for a time of the second threshold value. As a result, the efficiency of recovering the electric power generated by the motor generator 131 can be improved, and the occurrence of the lithium precipitation in the lithium-ion battery 111 can be suppressed.

### (2) Second Example

The lithium-ion battery 111 has a physical property that the lithium precipitation is more likely to rapidly occur as the temperature approaches an extremely low temperature. Therefore, the charging allowable electric power IWin also tends to be more sensitive to the current as the temperature is lower. The lithium-ion battery charging control of the second example corresponds to this tendency.

The lithium-ion battery charging control of the second example shown in FIG. 3 is different from the lithium-ion battery charging control of the first example shown in FIG. 2 (steps S201 to S206) in that a determination process of step S301 is performed before the lithium-ion battery charging control of the first example is started. For the lithium-ion battery charging control of the second example, the process of step S301 will be described below, and the description of the other processes having the same step numbers as the first example will be omitted.

As in the first example, the lithium-ion battery charging control of the second example is also started, for example, in a case where the CAN communication between the first controller 120 and the second controller 132 is interrupted, and the notification for the operation instruction (on the electric power generation amount) of the motor generator 131 from the first controller 120 to the second controller 132 is not given.

### Step S301

The first controller 120 determines whether or not a battery temperature T that is a temperature of the lithium-ion battery 111 is equal to or higher than a third threshold value. The determination is made to determine whether or not the temperature of the lithium-ion battery 111 is lower as the lithium precipitation is more likely to occur. The third threshold value is a predetermined temperature (battery connection permission temperature during the autonomous electric power generation) determined based on the physical property of the lithium-ion battery 111 at a low temperature, the first threshold value used in step S202, and the second threshold value used in step S205. For example, in a case where the assumption is made that a maximum current continuously flows through the lithium-ion battery 111, a time for the charging allowable electric power IWin to fall below the first threshold value and then to reach the lithium precipitation line is obtained for each predetermined temperature by simulation or the like, and a highest temperature at which the time of the second threshold value arrives earlier than the time for the charging allowable electric power IWin to reach the lithium precipitation line can be set as the third threshold value. In other words, the third threshold value can be a maximum value of the temperature that satisfies a condition that “the time for the charging allowable electric power IWin to reach the lithium precipitation line is longer than the time of the second threshold value”.

In a case where the first controller 120 determines that the battery temperature T is equal to or higher than the third threshold value (step S301, YES), the temperature of the lithium-ion battery 111 is not a low temperature at which the lithium precipitation is likely to occur, so that the process proceeds to step S201. On the other hand, in a case where the first controller 120 determines that the battery temperature T is lower than the third threshold value (step S301, NO), the temperature of the lithium-ion battery 111 is a low temperature at which the lithium precipitation is likely to occur, so that the process proceeds to step S206.

In the lithium-ion battery charging control of the second example, in a case where time for the charging allowable electric power IWin to fall below the first threshold value and then to reach the lithium precipitation line arrives earlier than the time of the second threshold value for determining whether or not to cut off the relay 112, the possibility of the lithium precipitation occurring in the lithium-ion battery 111 is extremely high, and thus the relay 112 is cut off by performing the processes of steps S201 to S205. As a result, the occurrence of the lithium precipitation in the lithium-ion battery 111 can be more safely avoided than in the first example.

### Action and Effect

As described above, with the charging system 100 according to the embodiment of the present disclosure, in the system configuration including the motor generator 131, the lithium-ion battery 111 that can accumulate the electric power generated by the motor generator 131, and the relay 112 that connects the motor generator 131 and the lithium-ion battery 111 to each other, in a case where the motor generator 131 cannot be controlled in accordance with the instruction on the electric power generation amount based on the information of the lithium-ion battery 111, when the possibility of the lithium precipitation in the lithium-ion battery 111 is estimated, the relay 112 is cut off.

With this control, in a case where the electric power generated by the motor generator 131 that performs the autonomous electric power generation based on the fail-safe is higher than the charging allowable electric power IWin of the lithium-ion battery 111 due to the CAN communication interruption or the like, the lithium-ion battery 111 can be avoided from being charged with the electric power exceeding the limit, and the lithium precipitation can be avoided from occurring.

Further, with the charging system 100 according to the present embodiment, even in a scene in which the motor generator 131 performs the autonomous electric power generation, the lithium-ion battery 111 is kept connected (the relay 112 is kept in the conduction state) as long as there is no possibility of the lithium precipitation in the lithium-ion battery 111. With this control, in the fail-safe mode, the electric power can be stably supplied from the MG unit 130 and the battery pack 110 to the auxiliary system (not shown) of the vehicle via the DC-DC converter 140.

Although the embodiment of the technique of the present disclosure has been described above, the present disclosure can be regarded as a battery charging control method executed by a control device including a processor and a memory provided in a charging system, a program of the battery charging control method, a computer-readable non-transitory recording medium storing the program, a vehicle in which the charging system including the control device is mounted, and the like, in addition to the charging system.

The charging system according to the present disclosure can be used in a case where the charging of the lithium-ion battery mounted in the vehicle is controlled.

What is claimed is:

1. A charging system mounted in a vehicle, the charging system comprising:
a motor generator;
a lithium-ion battery configured to accumulate an electric power generated by the motor generator;
a relay configured to electrically connect the motor generator and the lithium-ion battery to each other;
a first processor configured to acquire battery information including a temperature, a current, and a usage period of the lithium-ion battery and give an instruction on an electric power generation amount of the motor generator based on the battery information; and
a second processor configured to control an operation of the motor generator in accordance with the instruction from the first processor, wherein
the first processor is configured to, in a case where an interruption of the instruction to the second processor is detected,
calculate a charging allowable electric power that is an upper limit value of a charging electric power into the lithium-ion battery in which lithium precipitation does not occur, based on the battery information, and
cut off the relay when a state where the charging allowable electric power is lower than a predetermined electric power continues for a predetermined time or longer.

2. The charging system according to claim 1, wherein the first processor is configured to, in a case where the interruption of the instruction to the second processor is detected, cut off the relay when the temperature of the lithium-ion battery is lower than a predetermined temperature.

3. The charging system according to claim 1, wherein the first processor is configured to calculate the charging allowable electric power based on the temperature, a history of charging and discharging, and a degree of aging deterioration of the lithium-ion battery.

4. A vehicle comprising the charging system according to claim 1.
